(19) United States
(12) Patent Application Publication
(10) Pub. No.: US 2026/0266472 A1
(43) Pub. Date: Sep. 10, 2026

(54) METHODS FOR OPERATING AN OVEN APPLIANCE

(71) Applicant: Haier US Appliance Solutions, Inc., Wilmington, DE (US)

(72) Inventor: Anthony E. Kendall, Ooltewah, TN (US)

(21) Appl. No.: 19/070,602

(22) Filed: Mar. 5, 2025

(51) Int. Cl. F24C 7/08; F24C 7/06; H05B 1/02

(52) U.S. Cl. CPC F24C 7/087; F24C 7/067; H05B 1/0263; H05B 2203/005

(57) ABSTRACT

An oven includes a cabinet with a cooking chamber. Moreover, the oven includes first and second heating elements in thermal communication with the cooking chamber. Furthermore, the oven includes a controller in operative communication with the first and second heating elements. The controller is configured to receive a selected setpoint temperature. Additionally, the controller is configured to determine a difference between a first and second preheat lengths of time to heat the cooking chamber to the setpoint temperature. Furthermore, the controller is configured to adjust a time of operation ratio of the first and second heating elements based on the determined difference between the first and second preheat lengths of time. Moreover, the controller is configured to operate the first and second heating elements according to the adjusted time of operation ratio.

### FIELD

The subject matter of the present disclosure relates generally to an oven appliance and methods for operating an oven appliance.

### BACKGROUND

Oven appliances generally include a cabinet that defines a cooking chamber for cooking food items therein, such as by baking or broiling the food items. To heat the cooking chamber for cooking, oven appliances include one or more heating elements positioned at a top portion and/or bottom portion within the oven appliances. Some oven appliances also include a convection heating element and fan for convection cooking cycles. The heating element or elements may be used for various cycles of the oven appliance, such as a preheat cycle, a cooking cycle, or a self-cleaning cycle.

During a typical preheat cycle, the air and surfaces of the cooking chamber are heated to a set temperature, creating a heating environment within the cooking chamber for cooking food items that is maintained during the cooking cycle. Heating elements of the oven appliance generally preheat the cooking chamber to the set temperature within a generally consistent length of time. However, over time the heating elements of oven appliances may degrade due to use and normal wear and tear and/or the effectiveness/efficiency of the oven insulation may decline resulting in undesired loss of heat. As a result, the length of time to preheat the cooking chamber of an oven appliance at any particular set temperature may increase over time. The increased time to preheat the cooking chamber inconveniences users of the oven appliance and results in more energy consumed by the oven appliance.

Accordingly, an oven appliance with features for controlling a preheating cycle within a cooking chamber of the oven appliance to maintain the preheat time for a particular preheat temperature would be desirable.

### BRIEF DESCRIPTION

Aspects and advantages of the invention will be set forth in part in the following description, may be apparent from the description, or may be learned through practice of the invention.

In one exemplary embodiment, an oven appliance is provided. The oven appliance includes a cabinet. The cabinet defines a cooking chamber configured for receipt of food items for cooking. Furthermore, the oven appliance includes a first heating element. The first heating element is in thermal communication with the cooking chamber. Moreover, the oven appliance includes a second heating element. The second heating element is in thermal communication with the cooking chamber. Additionally, the oven appliance includes a controller. The controller is in operative communication with the first heating element and the second heating element. The controller is configured to receive a user selected setpoint temperature at which to heat the cooking chamber. Furthermore, the controller is configured to determine a difference between a first preheat length of time to heat the cooking chamber to the received user selected setpoint temperature and a second preheat length of time to heat the cooking chamber to the received user selected setpoint temperature. Moreover, the controller is configured to adjust a predetermined time of operation ratio of the first heating element to the second heating element based on the determined difference between the first preheat length of time and the second preheat length of time. Additionally, the controller is configured to operate the first heating element and the second heating element according to the adjusted predetermined time of operation ratio.

In another exemplary embodiment, a method of operating an oven appliance is provided. The oven appliance includes a cabinet. The cabinet defines a cooking chamber. Additionally, the oven appliance includes a first heating element. The first heating element is in thermal communication with the cooking chamber. Furthermore, the oven appliance includes a second heating element. The second heating element is in thermal communication with the cooking chamber. The method includes receiving, with a controller, a user selected setpoint temperature at which to heat the cooking chamber. Additionally, the method includes determining, with the controller, a difference between a first preheat length of time to heat the cooking chamber to the received user selected setpoint temperature and a second preheat length of time to heat the cooking chamber to the received user selected setpoint temperature. Furthermore, the method includes adjusting, with the controller, a predetermined time of operation ratio of the first heating element to the second heating element based on the determined difference between the first preheat length of time and the second preheat length of time. Moreover, the method includes operating, with the controller, the first heating element and the second heating element according to the adjusted predetermined time of operation ratio.

In another exemplary embodiment, a method of operating an oven appliance is provided. The oven appliance includes a cabinet. The cabinet defines a cooking chamber. Additionally, the oven appliance includes a first heating element. The first heating element is in thermal communication with the cooking chamber. Furthermore, the oven appliance includes a second heating element. The second heating element is in thermal communication with the cooking chamber. The method includes receiving, with a controller, a user selected setpoint temperature at which to heat the cooking chamber. Additionally, the method includes determining, with the controller, a preheat length of time to heat the cooking chamber to the received user selected setpoint temperature. Furthermore, the method includes selecting, with the controller, a predetermined time of operation ratio of the first heating element to the second heating element based on the determined preheat length of time. Moreover, the method includes operating, with the controller, the first heating element and the second heating element according to the selected predetermined time of operation ratio and without monitoring a temperature within the cooking chamber.

These and other features, aspects, and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a front view of an exemplary oven appliance according to one or more embodiments of the present subject matter.

FIG. 2 is a cross-sectional view of the oven appliance of FIG. 1 taken along the 2-2 line of FIG. 1.

FIG. 3 provides a flowchart illustrating a first exemplary method for operating an oven appliance according to the present subject matter.

FIG. 4 provides a flowchart illustrating a second exemplary method for operating an oven appliance according to the present subject matter.

The use of the same reference numbers in the figures denotes the same or similar features unless the context indicates otherwise.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the terms “first,” “second,” and “third” may be used interchangeably to distinguish one component from another and are not intended to signify location or importance of the individual components. The terms “includes” and “including” are intended to be inclusive in a manner similar to the term “comprising.” Similarly, the term “or” is generally intended to be inclusive (i.e., “A or B” is intended to mean “A or B or both”). The term “at least one of” in the context of, e.g., “at least one of A, B, and C” refers to only A, only B, only C, or any combination of A, B, and C. In addition, here and throughout the specification and claims, range limitations may be combined and/or interchanged. Such ranges are identified and include all the sub-ranges contained therein unless context or language indicates otherwise. For example, all ranges disclosed herein are inclusive of the endpoints, and the endpoints are independently combinable with each other. The singular forms “a,” “an,” and “the” include plural references unless the context clearly dictates otherwise.

Approximating language, as used herein throughout the specification and claims, may be applied to modify any quantitative representation that could permissibly vary without resulting in a change in the basic function to which it is related. Accordingly, a value modified by a term or terms, such as “generally,” “about,” “approximately,” and “substantially,” are not to be limited to the precise value specified. In at least some instances, the approximating language may correspond to the precision of an instrument for measuring the value, or the precision of the methods or machines for constructing or manufacturing the components and/or systems. For example, the approximating language may refer to being within a 10 percent margin, i.e., including values within ten percent greater or less than the stated value. In this regard, for example, when used in the context of an angle or direction, such terms include within ten degrees greater or less than the stated angle or direction, e.g., “generally vertical” includes forming an angle of up to ten degrees in any direction, e.g., clockwise or counterclockwise, with the vertical direction V.

The word “exemplary” is used herein to mean “serving as an example, instance, or illustration.” In addition, references to “an embodiment” or “one embodiment” does not necessarily refer to the same embodiment, although it may. Any implementation described herein as “exemplary” or “an embodiment” is not necessarily to be construed as preferred or advantageous over other implementations. Moreover, each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents.

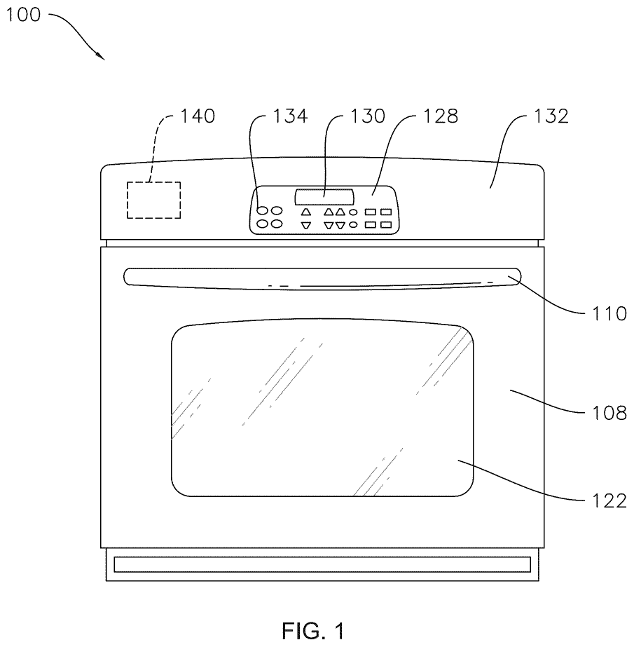

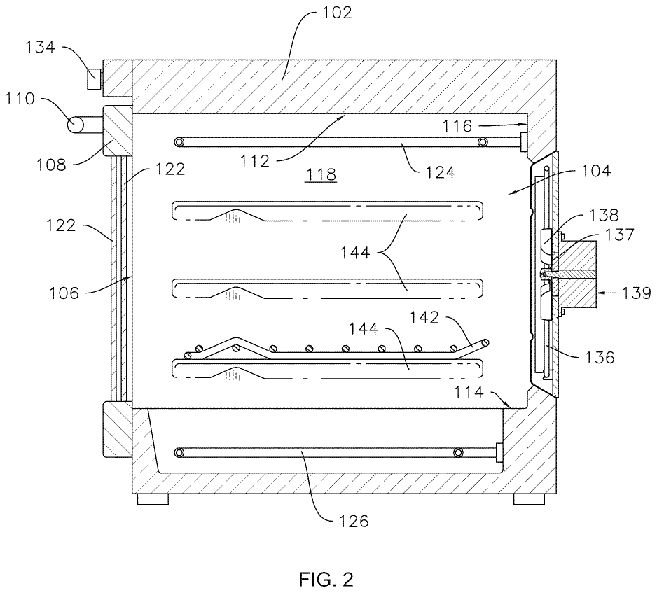

Referring to FIGS. 1 and 2, for this exemplary embodiment, oven appliance 100 includes an insulated cabinet 102 with an interior cooking chamber 104 defined by a top wall 112, a bottom wall 114, a back wall 116, and a pair of opposing side walls 118. Cooking chamber 104 is configured for the receipt of one or more food items to be cooked. Oven appliance 100 includes a door 108 pivotally mounted, e.g., with one or more hinges (not shown), to cabinet 102 at the opening 106 of cabinet 102 to permit selective access to cooking chamber 104 through opening 106. A handle 110 is mounted to door 108 and assists a user with opening and closing door 108. For example, a user can pull on handle 110 to open or close door 108 and access cooking chamber 104.

Oven appliance 100 can include a seal (not shown) between door 108 and cabinet 102 that assists with maintaining heat and cooking vapors within cooking chamber 104 when door 108 is closed as shown in FIGS. 1 and 2. Multiple parallel glass panes 122 provide for viewing the contents of cooking chamber 104 when door 108 is closed and assist with insulating cooking chamber 104. A baking rack 142 is positioned in cooking chamber 104 for the receipt of food items or utensils containing food items. Baking rack 142 is slidably received onto embossed ribs or sliding rails 144 such that backing rack 142 may be conveniently moved into and out of cooking chamber 104 when door 108 is open.

One or more heating elements may be provided at the top and/or bottom of the cooking chamber 104 and provide heat to the cooking chamber 104 for cooking. For example, in the embodiment shown in FIG. 2, oven appliance 100 includes a top heating element 124 and a bottom heating element 126. The top heating element 124 is positioned within an upper half of the cooking chamber 104. However, it should be appreciated that the top heating element 124 may be positioned outside of the cooking chamber 104, such as directly above the top wall 112. Furthermore, the bottom heating element 126 may be positioned within a lower half of the cooking chamber 104. However, it should be appreciated that the bottom heating element 126 may be positioned outside of the cooking chamber 104, such as directly below the bottom wall 114.

According to example embodiments, the heating element(s) may be an electrical heating element(s), which is powered by electrical power at a particular wattage and converted to heat that is emitted by the heating element(s). In some embodiments, the bottom heating element 126 may be a bake heating element 126 that is configured to emit heat waves within a baking temperature range, e.g., 300 degrees Fahrenheit through 499 degrees Fahrenheit. The bake heating element 126 may be powered by electrical power from a power source at a first wattage. Moreover, in some embodiments, the top heating element 124 may be a broil heating element 124 that is configured to emit heat waves within a broil temperature range, e.g., 500 degrees Fahrenheit through 550 degrees Fahrenheit. The broil heating element 124 may be powered by electrical power from the power source at a second wattage greater than the first wattage. Additionally, it should be appreciated that the bottom heating element 126 may be the broil heating element and the top heating element 124 may be the bake heating element.

Oven appliance 100 may also have a convection heating element 136 and convection fan 138 positioned adjacent back wall 116 of cooking chamber 104. Convection fan 138 is powered by a convection fan motor 139. Further, convection fan 138 can be a variable speed fan-meaning the speed of fan 138 may be controlled or set anywhere between and including, e.g., zero and one hundred percent (0% 100%). In certain embodiments, oven appliance 100 may also include a bidirectional triode thyristor (not shown), i.e., a triode for alternating current (TRIAC), to regulate the operation of convection fan 138 such that the speed of fan 138 may be adjusted during operation of oven appliance 100. The speed of convection fan 138 can be determined by a controller 140. In addition, a sensor 137 such as, e.g., a rotary encoder, a Hall effect sensor, or the like, may be included at the base of fan 138, for example, between fan 138 and motor 139 as shown in the exemplary embodiment of FIG. 2, to sense the speed of fan 138. The speed of fan 138 may be measured in, e.g., revolutions per minute (“RPM”). In some embodiments, the convection fan 138 may be configured to rotate in two directions, e.g., a first direction of rotation and a second direction of rotation opposing the first direction of rotation. For example, in some embodiments, reversing the direction of rotation, e.g., from the first direction to the second direction or vice versa, may still direct air from the back of the cavity. As another example, in some embodiments reversing the direction results in air being directed from the top and/or sides of the cavity rather than the back of the cavity.

In various embodiments, more than one convection heater, e.g., more than one convection heating element 136 and/or convection fan 138, may be provided. In such embodiments, the number of convection fans and convection heaters may be the same or may differ, e.g., more than one convection heating element 136 may be associated with a single convection fan 138. Similarly, more than one top heating element 124 and/or more than one bottom heating element 126 may be provided in various combinations, e.g., one top heating element 124 with two or more bottom heating elements 126, two or more top heating elements 124 with no bottom heating element 126, etc.

Oven appliance 100 includes a user interface 128 having a display 130 positioned on an interface panel 132 and having a variety of user input devices, e.g., controls 134. User interface 128 allows the user to select various options for the operation of oven appliance 100 including, e.g., various cooking and cleaning cycles. Operation of oven appliance 100 can be regulated by a controller 140 that is operatively coupled, i.e., in communication with, user interface 128, heating elements 124, 126, and other components of oven appliance 100 as will be further described.

For example, in response to user manipulation of the user interface 128, controller 140 can operate the heating element(s). Controller 140 can receive measurements from one or more temperature sensors. Controller 140 may also provide information such as a status indicator, e.g., a temperature indication, to the user with display 130. Controller 140 can also be provided with other features as will be further described herein.

Controller 140 may include a memory and one or more processing devices such as microprocessors, CPUs, or the like, such as general or special purpose microprocessors operable to execute programming instructions or micro-control code associated with operation of oven appliance 100. The memory may represent random access memory such as DRAM or read only memory such as ROM or FLASH. In one embodiment, the processor executes programming instructions stored in memory. The memory may be a separate component from the processor or may be included onboard within the processor. The memory can store information accessible by the processor(s), including instructions that can be executed by processor(s). For example, the instructions can be software or any set of instructions that when executed by the processor(s), cause the processor(s) to perform operations. For the embodiment depicted, the instructions may include a software package configured to operate the system to, e.g., execute the exemplary methods described below. Controller 140 may also be or include the capabilities of either a proportional (P), proportional-integral (PI), or proportional-integral-derivative (PID) control for feedback-based control implemented with, e.g., temperature feedback from the temperature sensor(s).

Controller 140 may be positioned in a variety of locations throughout oven appliance 100. In the illustrated embodiment, controller 140 is located next to user interface 128 within interface panel 132. In other embodiments, controller 140 may be located under or next to the user interface 128 otherwise within interface panel 132 or at any other appropriate location with respect to oven appliance 100. In the embodiment illustrated in FIG. 1, input/output (“I/O”) signals are routed between controller 140 and various operational components of oven appliance 100 such as heating elements 124, 126, 136, convection fan 138, controls 134, display 130, alarms, and/or other components as may be provided. In one embodiment, user interface 128 may represent a general purpose I/O (“GPIO”) device or functional block.

In the illustrated embodiments, the user input device is provided as touch type controls 134, however, it should be understood that controls 134 and the configuration of oven appliance 100 shown in FIG. 1 are illustrated by way of example only. For example, the user interface 128 may be provided as a touchscreen which provides both the display 130 and the controls 134. As further examples, the user interface 128 may include various input components, such as one or more of a variety of electrical, mechanical, or electro-mechanical input devices including rotary dials, push buttons, and touch pads. User interface 128 may include other display components, such as a digital or analog display device designed to provide operational feedback to a user. In some embodiments, user interface 128 may be in communication with controller 140 via one or more signal lines or shared communication busses. In other embodiments, the user interface 128 may be configured as an external computing device or remote user interface device, such as a smart phone, tablet, or other device capable of connecting to the controller 140. For example, the remote user interface device may be a handheld user interface 128 with a display 130 thereon, e.g., a touchscreen display. The remote user device may connect to the controller 140 wirelessly using any suitable wireless connection, such as wireless radio, Wi-Fi, Bluetooth, Zigbee, laser, infrared, and any other suitable device or interface. For example, in some embodiments, the remote user interface may be an application or “app” executed by a remote user interface device such as a smart phone or tablet. Signals generated in controller 140 may operate oven appliance 100 in response to user input via the user interface 128.

While oven appliance 100 is shown as a wall oven, the present invention could also be used with other cooking appliances such as, e.g., a stand-alone oven such as a toaster oven, an oven with a stove-top, or other configurations of such ovens. Numerous variations in the oven configuration are possible within the scope of the present subject matter. For example, variations in the type and/or layout of the controls 134, as mentioned above, are possible. As another example, the oven appliance 100 may include multiple doors 108 instead of or in addition to the single door 108 illustrated. Such examples include a dual cavity oven, a French door oven, and others. The examples described herein are provided by way of illustration only and without limitation.

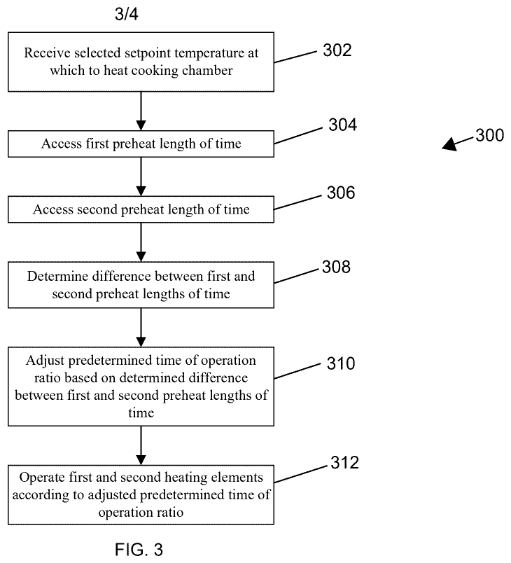

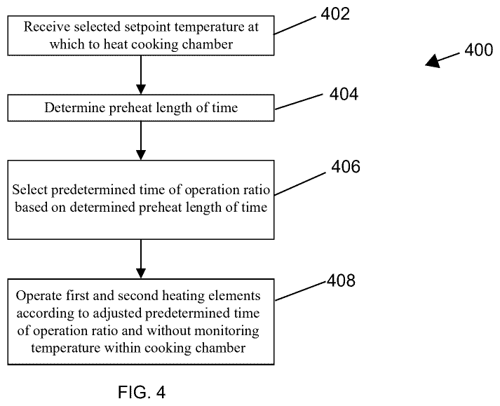

Referring now generally to FIGS. 3 and 4, the methods 300 and 400 may be interrelated and/or may have one or more steps from one of the methods 300 or 400 combined with one of the other methods 300 or 400. Thus, those of ordinary skill in the art will recognize that the various steps of the exemplary methods described herein may be combined in various ways to arrive at additional embodiments within the scope of the present disclosure.

FIGS. 3 and 4 depict steps in a particular order for purposes of illustration and discussion. Those of ordinary skill in the art, using the disclosures provided herein, will understand that (except as otherwise indicated) methods 300 and 400 are not mutually exclusive. Moreover, the steps of the methods 300 and 400 can be modified, adapted, rearranged, omitted, interchanged, or expanded in various ways without deviating from the scope of the present disclosure.

Furthermore, the skilled artisan will recognize the interchangeability of various features from different embodiments. Similarly, the various method steps and features described, as well as other known equivalents for each such methods and feature, can be mixed and matched by one of ordinary skill in this art to construct additional systems and techniques in accordance with principles of this disclosure. Of course, it is to be understood that not necessarily all such objects or advantages described above may be achieved in accordance with any particular embodiment. Thus, for example, those skilled in the art will recognize that the systems and techniques described herein may be embodied or carried out in a manner that achieves or optimizes one advantage or group of advantages as taught herein without necessarily achieving other objects or advantages as may be taught or suggested herein.

Turning now to FIG. 3, an embodiment of the present disclosure may include a method for operating an oven appliance, such as the exemplary oven appliance 100 described above in FIGS. 1 and 2.

As shown in FIG. 3, the method 300 includes receiving a selected setpoint temperature at which to heat a cooking chamber of an oven appliance, e.g., as indicated at (302) in FIG. 3. Specifically, the controller 140 may receive the setpoint or preheat temperature at which to preheat the cooking chamber 104 of oven appliance 100, such as from the user via the user input device, e.g., controls 134, of the oven appliance 100 and/or from a remote user interface device, e.g., smartphone, tablet, and/or the like. For example, the user may utilize the controls 134 to select the setpoint temperature of 350 degrees Fahrenheit at which to preheat the cooking chamber 104 of the oven appliance 100. The selected setpoint temperature of 350 degrees Fahrenheit is then received by the controller 140.

Thereafter, the method 300 may include accessing one or more preheat lengths of time for preheating the cooking chamber to the received selected setpoint temperature. For example, the method 300 may include accessing a first preheat length of time, e.g., as indicated at (304) in FIG. 3. The first preheat length of time may be a time taken to reach the received selected setpoint temperature at a predetermined time of operation ratio of a first heating element to a second heating element. The first preheat length of time may be a baseline preheat length of time, e.g., 600 seconds, at which the cooking chamber 104 of the oven appliance 100 is heated to the selected setpoint temperature received at (302). The baseline preheat length of time may be pre-programmed and stored within the memory of the controller 140 prior to use of the heating elements 124, 126 of the oven appliance 100 and accessed from the memory of the controller 140. Alternatively, the controller 140 may record the baseline preheat length of time within its memory during a preheat cycle at which the cooking chamber 104 of the oven appliance 100 is heated to the received selected setpoint temperature, e.g., 350 degrees Fahrenheit, at the predetermined time of operation ratio. In some embodiments, the recorded baseline preheat length of time may be an average of a plurality of recorded baseline preheat lengths of time. The baseline preheat length of time represents the length of time to preheat the cooking chamber 104 of the oven appliance 100 to a particular setpoint temperature, such as the received selected setpoint temperature, when the oven appliance 100 is a new/as-manufactured condition and prior to any deterioration of the heating elements 124, 126. As described herein, the predetermined time of operation ratio, also known as the duty cycle, may be a ratio of the amount of time that the bake heating element 126 is operated in a predetermined time segment, e.g., 30 seconds out of every 60 seconds, to the amount of time that the broil heating element 124 is operated in the predetermined time segment, e.g., 6 seconds out of every 60 seconds. Accordingly, the foregoing example corresponds to a 60% total duty cycle, with a 50% duty cycle for the bake element and a 10% duty cycle for the broil element, which may also be expressed as a five-to-one time of operation ratio of the first heating element to the second heating element.

Additionally, the method 300 may include accessing a second preheat length of time at which the cooking chamber is heated to the received selected setpoint temperature, e.g., as indicated at (306) in FIG. 3. The second preheat length of time, like the first preheat length of time, may be a time taken at the predetermined time of operation ratio of the first heating element to the second heating element. Where the first preheat time is a baseline time, as described above, the second preheat time may be recent preheat time, e.g., from one or more preheat operations which were performed more recently than the first preheat time was established. For example, the second preheat length of time, e.g., 630 seconds, may be the length of time during the most recent preheat cycle/operation at which the cooking chamber 104 was heated to the selected setpoint temperature received at (302) using the predetermined time of operation ratio. The second or recent preheat length of time may be greater than the first or baseline preheat length of time. The controller 140 may record the recent preheat length of time within its memory during the preheat cycle at which the cooking chamber 104 of the oven appliance 100 is heated to the received selected setpoint temperature, e.g., 350 degrees Fahrenheit, at the predetermined time of operation ratio. In some embodiments, the recorded recent preheat length of time may be an average of a plurality of recorded recent preheat lengths of time. The recent preheat length of time represents the length of time to preheat the cooking chamber 104 of the oven appliance 100 to a particular setpoint temperature, such as the received selected setpoint temperature, during the most recent preheat cycle/operation at which the cooking chamber 104 was heated to the particular setpoint temperature using the predetermined time of operation ratio. The recent preheat length of time may be a result of use, wear and tear, and/or the like of the bake heating element 126 and/or the broil heating element 124 over time. As a result, over time, it takes longer to preheat the cooking chamber 104 to a particular setpoint temperature at a particular predetermined time of operation ratio.

Moreover, the method 300 includes determining a difference between the first preheat length of time to heat the cooking chamber to the received selected setpoint temperature and the second preheat length of time to heat the cooking chamber to the received selected setpoint temperature, e.g., as indicated at (308) in FIG. 3. Specifically, the controller 140 may determine or calculate the difference between the recent preheat length of time described above at (306) and the baseline preheat length of time described above at (304) (e.g., where the recent preheat length of time may be greater than the baseline preheat length of time). The determined difference between the baseline and recent preheat lengths of time may equal or exceed a minimum threshold difference amount or value before adjusting the predetermined time of operation ratio described below at (310). For example, the predetermined time of operation ratio may not be adjusted until the determined difference between the baseline and recent preheat lengths of time is between 5% and 10% of the baseline preheat length of time.

Thereafter, the method 300 includes adjusting the predetermined time of operation ratio based on the determined difference between the first preheat length of time and the second preheat length of time, e.g., as indicated at (310) in FIG. 3. Specifically, the controller 140 may adjust the predetermined time of operation ratio such that operation of the broil heating element 124 and the bake heating element 126 at the adjusted predetermined time of operation ratio results in the cooking chamber 104 of the oven appliance 100 heated to the selected setpoint temperature within or by the baseline preheat length of time. For example, the controller 140 may adjust the predetermined time of operation ratio such that the amount of time that the broil heating element 124 is operated in the predetermined time segment is increased, e.g., 12 seconds out of every 60 seconds (i.e., a broil duty cycle or broil portion of the total duty cycle of 20% in this example). Additionally, the controller 140 may adjust the predetermined time of operation ratio such that the amount of time that the bake heating element 126 is operated is decreased or increased, e.g., 20 seconds out of every 60 seconds (33% bake duty cycle) or 48 seconds out of every 60 seconds (80% bake duty cycle, such that, in these examples, the total duty cycle may be between about 53% and about 100% after the adjustment). Accordingly, continuing the example, the adjusted time of operation ratio may be between about five to three (5:3 bake to broil) and about four to one (4:1 bake to broil), such that, as compared to the predetermined time of operation ratio (5:1 in this example, as noted above), the adjusted time of operation ratio includes a larger proportion of broil time and/or a greater total on time (greater total duty cycle) in order to reach the setpoint temperature in the desired length of time. It is to be understood that the foregoing time and ratio values are provided by way of example only and are in no way intended to limit the scope of the subject matter to any particular time values or ratios. In this respect, adjusting the predetermined time of operation ratio accounts for the use, wear and tear, etc. of the broil heating element 124 and the bake heating element 126 and, thus, permits the cooking chamber 104 to be heated to the selected setpoint temperature within or by the baseline preheat length of time.

Additionally, after adjusting the predetermined time of operation ratio, the method 300 includes operating the first heating element and the second heating element according to the adjusted predetermined time of operation ratio, e.g., as indicated at (312) in FIG. 3. Specifically, the controller 140 may operate the bake heating element 126 and the broil heating element 124 according to the predetermined time of operation ratio as adjusted at (310).

Another exemplary method of operating an oven appliance according to one or more embodiments of the present disclosure is illustrated in FIG. 4. As shown in FIG. 4, at (402), the exemplary method 400 includes receiving a selected setpoint temperature at which to heat a cooking chamber of an oven appliance, e.g., as described above with respect to (302) of method 300.

Thereafter, the method 400 includes determining a preheat length of time to heat the cooking chamber to the received selected setpoint temperature, e.g., as indicated at (404) in FIG. 4. Specifically, the controller 140 may select or determine the preheat length of time at which to preheat the cooking chamber 104 of the oven appliance 100 to the selected setpoint temperature received at (402). For example, the preheat length of time may be 600 seconds to preheat the cooking chamber 104 to a setpoint temperature of 350 degrees Fahrenheit.

Additionally, the method 400 includes selecting a predetermined time of operation ratio of a first heating element to a second heating element based on the determined preheat length of time, e.g., as indicated at (406) in FIG. 4. Specifically, the controller 140 may select the predetermined time of operation ratio based on the determined preheat length of time. For example, the controller 140 may access a look-up table within its memory that correlates the preheat length of time determined at (404) to time of operation ratio values.

Thereafter, at (408), the method 400 includes operating the first heating element and the second heating element according to the selected predetermined time of operation ratio without monitoring a temperature within a cooking chamber of the oven appliance. Specifically, the controller 140 operates the bake heating element 126 and the broil heating element 124 according the predetermined time of operation ratio selected at (406) without monitoring the temperature within the cooking chamber 104 of the oven appliance 100. For example, the controller 140 may operate the bake heating element 126 and the broil heating element 124 only taking time into account, e.g., the predetermined time of operation ratio of the bake heating element 126 to the broil heating element 124, and without monitoring or otherwise considering the temperature within the cooking chamber 104.

Additionally, with respect to methods 300 and 400, in some embodiments, when adjusting the predetermined time of operation ratio at (310) and/or at (406), the controller 140 may increase a current length of time for operating the broil heating element 124 from a previous length of time that the broil heating element 124 was operated for the selected setpoint temperature received at (302) and at (402). As described herein, the current length of time for operating the broil heating element 124 may be the length of time that the broil heating element 124 is operated within a predetermined time period, e.g., 12 seconds out of every 60 seconds, for a present or current preheat cycle at the received selected setpoint temperature. Additionally, the previous length of time that the broil heating element 124 was operated may be the length of time that the broil heating element 124 was operated within the predetermined time period, e.g., 6 seconds out of every 60 seconds, for the most recent preheat cycle of the oven appliance 100 that was prior to the present or current preheat cycle. The current length of time for operating the broil heating element 124 may thus be increased, 6 seconds out of every 60 seconds to 12 seconds out of every 60 seconds, from the previous length of time for operating the broil heating element 124. The current length of time for operating the broil heating element 124 is either lesser than or equal to the recent preheat length of time described above. Thereafter, the cooking chamber 104 may be heated to the received user selected setpoint temperature within the recent preheat length of time in response to operating the broil heating element 124 for the increased current length of time.

Additionally, or alternatively, with respect to methods 300 and 400, in some embodiments, when adjusting the predetermined time of operation ratio, the controller 140 may decrease a current length of time for operating the bake heating element 126 from a previous length of time that the bake heating element 126 was operated for the received user selected setpoint temperature and increase the current length of time for operating the broil heating element 124 from the previous length of time that the broil heating element 124 was operated for the received user selected setpoint temperature. As described herein, the current length of time for operating the bake heating element 126 may be the length of time that the bake heating element 126 is operated within the predetermined time period, e.g., 30 seconds out of every 60 seconds, for the present or current preheat cycle at the received selected setpoint temperature. Additionally, the previous length of time that the bake heating element 126 was operated may be the length of time that the bake heating element 126 was operated within the predetermined time period, e.g., 48 seconds out of every 60 seconds, for the most recent preheat cycle of the oven appliance 100 that was prior to the present or current preheat cycle. The current length of time for operating the bake heating element 126 may thus be decreased, 48 seconds out of every 60 seconds to 30 seconds out of every 60 seconds, from the previous length of time for operating the bake heating element 126. Likewise, the current length of time for operating the broil heating element 124 may be increased. The current length of time for operating the bake heating element 126 and the current length of time for operating the broil heating element 124 combined are lesser than or equal to the recent preheat length of time described above. Thereafter, the cooking chamber 104 may be heated to the received user selected setpoint temperature within the recent preheat length of time in response to operating the broil heating element 124 for the increased current length of time and operating the bake heating element 126 for the decreased current length of time.

Additionally, or alternatively, with respect to methods 300 and 400, in some embodiments, when adjusting the predetermined time of operation ratio, the controller 140 may increase the current length of time for operating the bake heating element 126 from the previous length of time that the bake heating element 126 was operated for the received user selected setpoint temperature. The current length of time for operating the bake heating element 126 is lesser than or equal to the recent preheat length of time described above. Thereafter, the cooking chamber 104 may be heated to the received user selected setpoint temperature within the recent preheat length of time in response to operating the bake heating element 126 for the increased current length of time.

Additionally, or alternatively, with respect to methods 300 and 400, in some embodiments, when adjusting the predetermined time of operation ratio, the controller 140 may increase a first or bake current length of time for operating the bake heating element 126 from the previous length of time that the bake heating element 126 was operated for the received user selected setpoint temperature and increase a second or broil current length of time for operating the broil heating element 124 from the previous length of time that the broil heating element 124 was operated for the received user selected setpoint temperature. The bake current length of time for operating the bake heating element 126 and the broil current length of time for operating the broil heating element 124 combined are lesser than or equal to the recent preheat length of time described above. Thereafter, the cooking chamber 104 may be heated to the received user selected setpoint temperature within the recent preheat length of time in response to operating the bake heating element 126 for the increased bake current length of time and operating the broil heating element 124 for the increased broil length of time.

This written description uses examples to disclose the invention, including the best mode, and also to enable any person skilled in the art to practice the invention, including making and using any devices or systems and performing any incorporated methods. The patentable scope of the invention is defined by the claims and may include other examples that occur to those skilled in the art. Such other examples are intended to be within the scope of the claims if they include structural elements that do not differ from the literal language of the claims or if they include equivalent structural elements with insubstantial differences from the literal language of the claims.

What is claimed is:

1. An oven appliance comprising:
a cabinet defining a cooking chamber configured for receipt of food items for cooking;
a first heating element in thermal communication with the cooking chamber;
a second heating element in thermal communication with the cooking chamber; and
a controller in operative communication with the first heating element and the second heating element, the controller configured to:
receive a user selected setpoint temperature at which to heat the cooking chamber;
determine a difference between a first preheat length of time to heat the cooking chamber to the received user selected setpoint temperature and a second preheat length of time to heat the cooking chamber to the received user selected setpoint temperature;
adjust a predetermined time of operation ratio of the first heating element to the second heating element based on the determined difference between the first preheat length of time and the second preheat length of time; and
operate the first heating element and the second heating element according to the adjusted predetermined time of operation ratio.

2. The oven appliance of claim 1, wherein:
the first preheat length of time is a baseline preheat length of time to heat the cooking chamber to the received user selected setpoint temperature at the predetermined time of operation ratio; and
the second preheat length of time is a recent preheat length of time to heat the cooking chamber to the received user selected setpoint temperature at the predetermined time of operation ratio, the recent preheat length of time greater than the baseline preheat length of time.

3. The oven appliance of claim 1, wherein:
the first heating element comprises a bake heating element positioned within a lower half of the cooking chamber; and
the second heating element comprises a broil heating element positioned within an upper half of the cooking chamber.

4. The oven appliance of claim 1, wherein:
the first heating element is a bake heating element that is powered by electrical power at a first wattage for converting to heat; and
the second heating element is a broil heating element that is powered by electrical power at a second wattage for converting to heat, the second wattage greater than the first wattage.

5. A method for operating an oven appliance, the oven appliance comprising a cabinet defining a cooking chamber, a first heating element in thermal communication with the cooking chamber, and a second heating element in thermal communication with the cooking chamber, the method comprising:
receiving, with a controller, a user selected setpoint temperature at which to heat the cooking chamber;
determining, with the controller, a difference between a first preheat length of time to heat the cooking chamber to the received user selected setpoint temperature and a second preheat length of time to heat the cooking chamber to the received user selected setpoint temperature;
adjusting, with the controller, a predetermined time of operation ratio of the first heating element to the second heating element based on the determined difference between the first preheat length of time and the second preheat length of time; and
operating, with the controller, the first heating element and the second heating element according to the adjusted predetermined time of operation ratio.

6. The method of claim 5, wherein:
the first preheat length of time is a baseline preheat length of time to heat the cooking chamber to the received user selected setpoint temperature at the predetermined time of operation ratio; and
the second preheat length of time is a recent preheat length of time to heat the cooking chamber to the received user selected setpoint temperature at the predetermined time of operation ratio, the recent preheat length of time greater than the baseline preheat length of time.

7. The method of claim 5, wherein adjusting the predetermined time of operation ratio comprises:
increasing, with the controller, a current length of time for operating the second heating element from a previous length of time that the second heating element was operated for the received user selected setpoint temperature,
wherein, the increased current length of time for operating the second heating element is lesser than or equal to the second preheat length of time.

8. The method of claim 7, whereby the cooking chamber is heated to the received user selected setpoint temperature within the second preheat length of time in response to operating the second heating element for the increased current length of time.

9. The method of claim 5, wherein adjusting the predetermined time of operation ratio comprises:
decreasing, with the controller, a current length of time for operating the first heating element from a previous length of time that the first heating element was operated for the received user selected setpoint temperature; and
increasing, with the controller, a current length of time for operating the second heating element from a previous length of time that the second heating element was operated for the received user selected setpoint temperature,
wherein, the increased current length of time for operating the second heating element and the decreased current length of time for operating the first heating element combined are lesser than or equal to the second preheat length of time.

10. The method of claim 9, whereby the cooking chamber is heated to the received user selected setpoint temperature within the second preheat length of time in response to operating the first heating element for the decreased current length of time and operating the second heating element for the increased current length of time.

11. The method of claim 5, wherein adjusting the predetermined time of operation ratio comprises:
increasing, with the controller, a current length of time for operating the first heating element from a previous length of time that the first heating element was operated for the received user selected setpoint temperature,
wherein, the increased current length of time for operating the first heating element is lesser than or equal to the second preheat length of time.

12. The method of claim 11, whereby the cooking chamber is heated to the received user selected setpoint temperature within the second preheat length of time in response to operating the first heating element for the increased current length of time.

13. The method of claim 5, wherein adjusting the predetermined time of operation ratio comprises:
increasing, with the controller, a first current length of time for operating the first heating element from a previous length of time that the first heating element was operated for the received user selected setpoint temperature; and
increasing, with the controller, a second current length of time for operating the second heating element from a previous length of time that the second heating element was operated for the received user selected setpoint temperature,
wherein, the increased first current length of time for operating the first heating element and the increased second current length of time for operating the second heating element combined are lesser than or equal to the second preheat length of time.

14. The method of claim 13, whereby the cooking chamber is heated to the received user selected setpoint temperature within the second preheat length of time in response to operating the first heating element for the increased first current length of time and operating the second heating element for the increased second current length of time.

15. A method for operating an oven appliance, the oven appliance comprising a cabinet defining a cooking chamber, a first heating element in thermal communication with the cooking chamber, and a second heating element in thermal communication with the cooking chamber, the method comprising:
receiving, with a controller, a user selected setpoint temperature at which to heat the cooking chamber;
determining, with the controller, a preheat length of time to heat the cooking chamber to the received user selected setpoint temperature;
selecting, with the controller, a predetermined time of operation ratio of the first heating element to the second heating element based on the determined preheat length of time; and
operating, with the controller, the first heating element and the second heating element according to the selected predetermined time of operation ratio and without monitoring a temperature within the cooking chamber.

16. The method of claim 15, wherein selecting the predetermined time of operation ratio comprises:
increasing, with the controller, a current length of time for operating the second heating element from a previous length of time that the second heating element was operated for the received user selected setpoint temperature,
wherein, the increased current length of time for operating the second heating element is lesser than or equal to the preheat length of time.

17. The method of claim 16, whereby the cooking chamber is heated to the received user selected setpoint temperature within the preheat length of time in response to operating the second heating element for the increased current length of time.

18. The method of claim 15, wherein adjusting the predetermined time of operation ratio comprises:
decreasing, with the controller, a current length of time for operating the first heating element from a previous length of time that the first heating element was operated for the received user selected setpoint temperature; and
increasing, with the controller, a current length of time for operating the second heating element from a previous length of time that the second heating element was operated for the received user selected setpoint temperature,
wherein, the increased current length of time for operating the second heating element and the decreased current length of time for operating the first heating element combined are lesser than or equal to the preheat length of time.

19. The method of claim 18, whereby the cooking chamber is heated to the received user selected setpoint temperature within the preheat length of time in response to operating the first heating element for the decreased current length of time and operating the second heating element for the increased current length of time.
